(19) United States
(12) Patent Application Publication
(10) Pub. No.: US 2020/0234617 A1
(43) Pub. Date: Jul. 23, 2020

(54) DISPLAY APPARATUS AND METHOD FOR OPTIMIZING DISPLAY MODE

(71) Applicants: Coretronic Corporation, Hsin-Chu (TW); Optoma Corporation, New Taipei City (TW)

(72) Inventors: Hsin-Yueh Chang, Hsin-Chu (TW); Li-Ming Chen, Hsin-Chu (TW); Yuan-Mao Tsui, Hsin-Chu (TW)

(73) Assignees: Coretronic Corporation, Hsin-Chu (TW); Optoma Corporation, New Taipei City (TW)

(21) Appl. No.: 16/741,763

(22) Filed: Jan. 14, 2020

(30) Foreign Application Priority Data
Jan. 18, 2019 (CN) 201910049442.8

(51) Int. Cl. G09G 1/16; G09G 5/00; G06F 3/14

(52) U.S. Cl. CPC G09G 1/165; G09G 2320/08; G06F 3/1446; G09G 5/005

(57) ABSTRACT

A display apparatus and method for optimizing a display mode are provided. The display apparatus and method for optimizing a display mode include a display, a memory and a processor. The memory includes a sampling module, a neural network module and a mode selection module. The display displays an image data stream and has display modes. The sampling module samples the image data stream in a first time interval to generate sampling data in response to a trigger signal. The neural network module classifies the sampling data through the neural network to generate a classification outcome corresponding to the display modes. The mode selection module selects one of the display modes according to the classification outcome to display the image data stream.

### CROSS-REFERENCE TO RELATED APPLICATION

This application claims the priority benefit of China application serial no. 201910049442.8, filed on Jan. 18, 2019. The entirety of the above-mentioned patent application is hereby incorporated by reference herein and made a part of this specification.

### BACKGROUND OF THE INVENTION

### Field of the Invention

The disclosure relates to a display apparatus and a method for optimizing a display mode.

### Description of Related Art

Nowadays, most display apparatuses advertise providing multiple preset display modes for the user to adjust according to their preference or the image as played, so as to change the parameters such as brightness, color temperature, contrast, saturation and sharpness of the display apparatus to optimize the displaying state of the display apparatus. As such, when playing images of all kinds such as texts, sports games or movies, the user may have different watching experiences by adjusting the display mode, and may even reduce the eye fatigue caused by watching the display apparatus for a long time. In general, the manufacturer presets the array display module in the display apparatus, and each display module corresponds to different usage scenarios. When the user needs to switch the display mode, the user has to switch manually, which allows the user to determine which of the default display mode provided by the display apparatus is suitable according on their own. However, manual operation to switch the display mode gets more and more complex. Usually, the user needs a certain level of knowledge to properly use the display mode functions. For the general public, manually switching the display mode may be a barrier quite difficult to reach. Moreover, once the content being played changes, the user needs to switch the display mode again. In light of the above, the function of the display mode is quite inconvenient for the user, so the user rarely adjusts the display modes of the display apparatus.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY OF THE INVENTION

The disclosure relates to a display apparatus and a method for optimizing a display mode that allows the apparatus select a suitable display mode automatically.

A display apparatus and a method for optimizing a display mode are provided. The display apparatus and the method of the disclosure automatically adjust the display mode according to the content that is played in a time interval, so that the user has a comfortable viewing experience at all times.

Other objectives and advantages of the invention can be further understood from the technical features disclosed in the invention.

Other features and advantages of the embodiments of the disclosure are illustrated by the technical features broadly embodied and described as follows.

In order to achieve one or a part of or all of the above purposes or other purposes, the disclosure provides a display apparatus for optimizing a display mode, including: a display, a memory and a processor, wherein the display is configured to display an image data stream and has a plurality of display modes. The memory is configured to store a plurality of modules. The processor is coupled to the display and the memory. The processor accesses and executes the plurality of modules, and the plurality of modules includes a sampling module, a neural network module and a mode selection module. The sampling module samples the image data stream in a first time interval in response to a trigger signal to generate a plurality of sampling data. The neural network module classifies the plurality of sampling data through the neural network to generate a classification outcome corresponding to the plurality of display modes. The mode selection module selects one of the plurality of display modes according to the classification outcome to display the image data stream.

In order to achieve one or a part of or all of the above purposes or other purposes, the disclosure provides a method for optimizing a display mode, including: a display displaying an image data stream, wherein the display has a plurality of display modes, the image data stream is sampled in a first time interval in response to a trigger signal to generate a plurality of sampling data, a plurality of sampling data is classified by the neural network to generate a classification outcome corresponding to the plurality of display modes, and one of the plurality of display modes is selected according to the classification outcome to display the image data stream.

Based on the above, the display apparatus and method of the disclosure automatically adjust the display mode according to the content that is played, so that the user has a comfortable viewing experience without manual intervention. On the other hand, since the display apparatus of the disclosure does not require manual intervention, it also facilitates development of much more delicate display modes for enhancing the user's watching experience.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a display apparatus for optimizing a display mode according to an embodiment of the disclosure.

FIG. 2 is a flowchart of a method for optimizing a display mode according to an embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

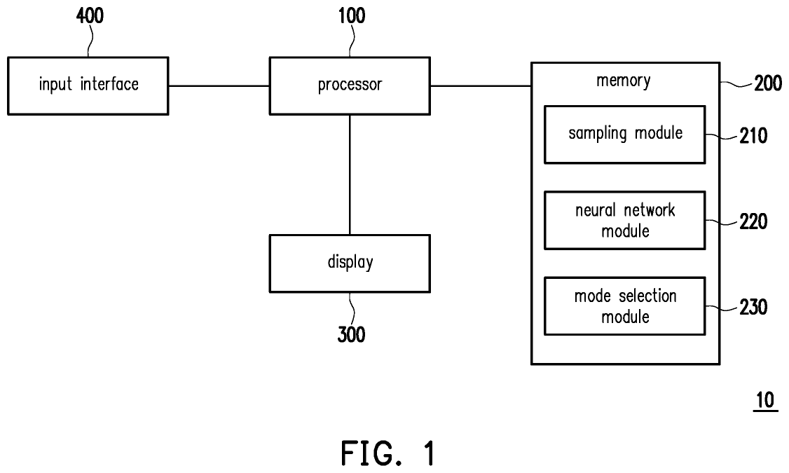

FIG. 1 is a schematic view of a display apparatus 10 for optimizing a display mode according to an embodiment of the disclosure. Referring to FIG. 1, the display apparatus 10 of this embodiment is an electronic apparatus capable of displaying an image, such as a television, a smart phone, a personal digital assistant (PDA), a tablet personal computer, an electronic book, a game console, and a notebook computer, but the disclosure is not limited thereto. The display apparatus 10 may include a processor 100, a memory 200, a display 300 and an input interface 400, of which the functions are described below.

The processor 100 is a single-core or multi-core central processing unit (CPU), a programmable microprocessor for general or special use, a digital signal processor (DSP), a programmable controller, an application specific integrated circuit (ASIC), a programmable logic device (PLD), a graphics processing unit (GPU), other similar devices, or a combination of the foregoing, for example. The processor 100 is coupled to the memory 200, the display 300 and the input interface 400 and capable of accessing and executing the modules and various applications stored in the memory 200.

The memory 200 is a stationary or movable random access memory (RAM) in any form, a read-only memory (ROM), a flash memory, a hard disc, other similar devices, or a combination of the foregoing, for example. The memory 200 is configured to record a plurality of modules and various applications that the processor 100 is capable of executing. The plurality of modules may include a sampling module 210, a neural network module 220 and a mode selection module 230, of which the functions will be described in the following.

The display 300 is a display panel, a liquid-crystal display (LCD), a light-emitting diode (LED) display, a vacuum fluorescent display (VFD), a plasma display panel (PDP), an organic light-emitting diode (OLED) or a field-emission display (FED), for example. The display 300 is configured to display an image data stream.

The input interface 400 is configured to provide a wireless or wired data transmission function that allows direct data transmission or communication between the display apparatus 10 and another electronic apparatus by using the input interface 400. It should be noted that, the signal transmission range of the input interface 400 depends on the hardware type or signal transmission method thereof. For example, the input interface 400 supports different transmission techniques, such as infrared communication technique, Bluetooth communication technique, or near field communication (NFC).

In this embodiment, the display 300 is configured to display an image data stream. The image data stream may be input to the display 300 through an interface such as a video graphics array (VGA), a digital visual interface (DVI) or a high definition multimedia interface

(HDMI). The image data stream may be from various types of sources, such as a cable television signal, a wireless television signal, a digital television signal or an image file stored in a storage media (such as a video tape, a DVD, a digital video disc and a Blu-ray disc), but the disclosure is not limit thereto. In addition, the display 300 may have various display modes, such as: a text mode, a theater mode and a photo mode for use in different situations. Each display mode corresponds to a set of display parameters, wherein the display parameters may include parameters of such as brightness, color temperature, contrast, saturation or sharpness.

The sampling module 210 samples the image data stream in a first time interval in response to a trigger signal to generate a plurality of sampling data. The plurality of sampling data respectively corresponds to different time points of the first time interval. Since the image data stream changes over time, sampling data sampled at different time points may be different.

The trigger signal may be generated by the processor 100. Specifically, the processor 100 may generate the trigger signal in response to one of a plurality of events, wherein the plurality of events may includes that a scene of the image data stream is changed; a source of the image data stream is changed; the processor 100 receives a control signal from the input interface 400; or the image data stream starts to play.

For example, if the source of the image data stream is a digital video disc and the digital video disc stores a plurality of preset scenes, the processor 100 may detect whether information representing a switching of scene appears in the image data stream when the image data stream is played. If the processor 100 detects the information representing the switching of scene, the processor 100 generates a trigger signal. For another example, if the source of the image data stream is switched from a cable television signal to a digital video disc, the processor 100 may generate the trigger signal based on the change of source of the image data stream. For another example, if a user of the display apparatus 10 sends a control signal to the input interface 400 via a remote controller, the processor 100 may receive a control signal forwarded from the input interface 400 and generate the trigger signal in response to the control signal. For another example, if the power of the display apparatus 10 is turned on, the processor 100 may generate the trigger signal based on the image data stream starts playing.

In an embodiment, the trigger signal may be a periodic signal. For example, the processor 100 may generate a trigger signal every ten minutes. The time length of each cycle may be default or may be set by the user.

The neural network module 220 classifies the plurality of sampling data through the neural network to generate a classification outcome corresponding to the plurality of display modes. For example, when the sampling data is a text image, the neural network module 220 classifies the sampling data of text image to a display mode suitable for presenting texts, and the neural network module 220 generates a label corresponding to the display mode suitable for presenting texts. The label is, for example, corresponding to a text mode. The plurality of display modes may include at least a first display mode and a second display mode, and the classification outcome may include at least a first label corresponding to the first display mode and at least a second label corresponding to the second display mode. The neural network module 220 registers a sampling data on the neural network to generate a label corresponding to the display mode of the plurality of sampling data. For example, if the neural network determines that a sampling data corresponds to the first display mode, i.e., the neural network classifies the sampling data as corresponding to the first display mode, the neural network module 220 generates a first label corresponding to the first display mode. On the other hand, if the neural network determines that a sampling data corresponds to the second display mode, the neural network module 220 generates a second label corresponding to the second display mode. After the neural network module 220 completes the classification of all of the plurality of sampling data, the neural network module 220 generates a classification outcome corresponding to a plurality of display modes. The classification outcome includes a plurality of labels respectively corresponding to a plurality of sampling data, and each one of the labels corresponds to one of the plurality of display modes.

The neural network classifies a plurality of sampling data to generate a classification outcome corresponding to a plurality of display modes. The neural network of the disclosure may be, for example, an artificial neural network (ANN) based on VGG, GoogleNet, ResNet, or DenseNet technologies, or may be a convolutional neural network (CNN), and the disclosure is not limited thereto. In addition, with the continuing evolution of the neural network technology, the neural network is replaceable by a more effective one. In an embodiment, the designer may select the most suitable neural network architecture according to the hardware performance of the display apparatus 10. In another embodiment, the number of the display modes of the display apparatus allows fine tune of new weight parameters under the existing neural network parameters to generate a new display mode. Thus, it is not necessary to train the neural network from the beginning again.

The mode selection module 230 selects one of the plurality of display modes to display the image data stream according to the classification outcome. Specifically, the mode selection module 230 selects the first display mode to display the image data stream based on that a first number of the at least a first label is greater than a second number of the at least a second label. For example, the mode selection module 230 selects a display mode to be used according to the number of the label corresponding to each of the display modes. If the classification outcome includes two types of labels: a first label corresponding to the first display mode and a second label corresponding to the second display mode, the mode selection module 230 selects the first display mode instead of the second mode to display the image data stream in the future based on that the first number of the first label is greater than the second number of the second label. For example, the classification outcome includes 100 labels corresponding to different display modes, of which 65 labels correspond to a text mode, 30 labels correspond to a theater mode, and 5 labels correspond to a photo mode, the mode selection module 230 selects the text mode to display the image data stream according to said classification outcome.

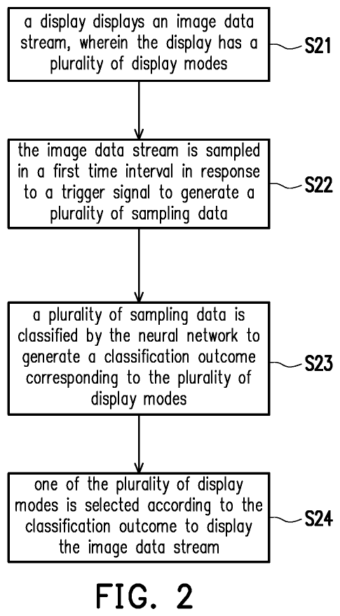

In other words, the mode selection module 230 selects a display mode to be used with the concept similar to voting, and each sampling data represents a voter. For example, after the mode selection module 230 classifies a sampling data as corresponding to the first display mode, the mode selection module 230 generates a first label corresponding to the first display mode. Similarly, if another sampling data is also classified as corresponding to the first display mode, the mode selection module 230 generates another first label corresponding to the first display mode as well. The number of the first labels represents the number of votes for the first display mode. Similarly, other display modes receive their number of votes correspondingly. Finally, the mode selection module 230 selects the display mode with the most votes (i.e., the display mode with the greatest number of labels) to display the image data stream. Compared to the display mode selected according to a single sampling data, the display mode selected according to multiple sampling data is adapted to more types of image data. As such, the user does not feel that the display 300 frequently switches the display mode, and thereby has a good watching experience. FIG. 2 is a flowchart of a method for optimizing a display mode according to an embodiment of the disclosure. The method for optimizing the display mode is applicable by the display apparatus. In step S21, a display displays an image data stream, wherein the display has a plurality of display modes. In step S22, the image data stream is sampled in a first time interval in response to a trigger signal to generate a plurality of sampling data. In step S23, a plurality of sampling data is classified by the neural network to generate a classification outcome corresponding to the plurality of display modes. In step S24, one of the plurality of display modes is selected according to the classification outcome to display the image data stream.

In summary, the display apparatus of the present disclosure automatically adjusts the display mode according to the content that is played, so that the user has a comfortable viewing experience without manual intervention. The content that is played, as referred to in the present disclosure, is not limited to a video, an image, a display screen of word processing or a display screen of gaming. In addition, the mechanism of automatically adjusting the display mode of the disclosure is applicable to various situations. Even if, for example, a change of scene of the image data stream occurs, or a change of source of the image data stream occurs, the user does not need to manually intervene in the selection process of the display mode. On the other hand, the neural network used in the disclosure allows update and optimization with the technology development or the user's feedback, and also allows different display apparatus hardware to select a suitable neural network for use.

The embodiments described hereinbefore are chosen and described in order to best explain the principles of the disclosure and its best mode practical application. It is not intended to be exhaustive to limit the disclosure to the precise form or to the exemplary embodiments disclosed. Namely, persons skilled in the art are enabled to understand the disclosure through various embodiments with various modifications as are suited to the particular use or implementation contemplated. It is intended that the scope of the disclosure be defined by the claims appended hereto and their equivalents in which all terms are meant in their broadest reasonable sense unless otherwise indicated. Any of the embodiments or any of the claims of the disclosure does not necessarily achieve all of the advantages or features disclosed by the disclosure. Moreover, the abstract and the title of the invention are merely used to aid in search of patent files and are not intended to limit the scope of the disclosure. In addition, terms such as “first” and “second” in the specification or claims are used only to name the elements or to distinguish different embodiments or scopes and should not be construed as the upper limit or lower limit of the number of any element.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display apparatus for optimizing a display mode, comprising a display, configured to display an image data stream, wherein the display has a plurality of display modes;
a memory, configured to store a plurality of modules; and
a processor, coupled to the display and the memory, wherein the processor is configured to access and execute the plurality of modules, and the plurality of modules comprising:
a sampling module, in response to a trigger signal, sampling the image data stream in a first time interval to generate a plurality of sampling data;
a neural network module, classifying the plurality of sampling data through the neural network to generate a classification outcome corresponding to the plurality of display modes; and
a mode selection module, selecting one of the plurality of display modes according to the classification outcome to display the image data stream.

2. The display apparatus for optimizing the display mode according to claim 1, wherein
the plurality of display modes comprise a first display mode and a second display mode,
the classification outcome comprises at least a first label corresponding to the first display mode and at least a second label corresponding to the second display mode, and
the mode selection module selects the first display mode to display the image data stream based on that a first number of the at least a first label is greater than a second number of the at least a second label.

3. The display apparatus for optimizing the display mode according to claim 1, wherein the processor generates the trigger signal in response to one of a plurality of events, wherein the plurality of events comprises:
a scene of the image data stream being changed;
a source of the image data stream being changed;
the processor receiving a control signal from an input interface, wherein the input interface is coupled to the processor; and
the image data stream starting to play.

4. The display apparatus for optimizing the display mode according to claim 1, wherein the trigger signal is a periodic signal.

5. The display apparatus for optimizing the display mode according to claim 1, wherein the plurality of sampling data respectively correspond to a plurality of different time points in the first time interval.

6. A method for optimizing a display mode, comprising:
a display displaying an image data stream, wherein the display has a plurality of display modes;
sampling the image data stream in a first time interval in response to a trigger signal to generate a plurality of sampling data;
classifying a plurality of sampling data by a neural network to generate a classification outcome corresponding to the plurality of display modes; and
selecting one of the plurality of display modes according to the classification outcome to display the image data stream.

7. The method for optimizing the display mode according to claim 6, wherein the plurality of display modes comprise a first display mode and a second display mode, the classification outcome comprises at least a first label corresponding to the first display mode and at least a second label corresponding to the second display mode, and selecting one of the plurality of display modes according to the classification outcome to display the image data stream comprises:
selecting the first display mode for displaying the image data stream based on that a first number of the at least a first label is greater than a second number of the at least a second label.

8. The method for optimizing the display mode according to claim 6, wherein the trigger signal is triggered in response to one of a plurality of events, and the plurality of events comprises:
a scene of the image data stream being changed;
a source of the image data stream being changed;
receiving a control signal; and
the image data stream starting to play.

9. The method for optimizing the display mode according to claim 6, wherein the trigger signal is a periodic signal.

10. The method for optimizing the display mode according to claim 6, wherein the plurality of sampling data respectively correspond to a plurality of different time points in the first time interval.
